(19) United States
(12) Patent Application Publication
(10) Pub. No.: US 2015/0089114 A1
(43) Pub. Date: Mar. 26, 2015

(54) COMMUNICATION DEVICE

(71) Applicant: SEIKO EPSON CORPORATION, Tokyo (JP)

(72) Inventor: Shigeru KAWACHI, Shiojiri (JP)

(21) Appl. No.: 14/462,208

(22) Filed: Aug. 18, 2014

(30) Foreign Application Priority Data
Sep. 24, 2013 (JP) 2013-196657

(51) Int. Cl. G06F 13/38; G06F 13/42

(52) U.S. Cl. CPC G06F 13/385; G06F 13/4221; G06F 2213/0042
USPC 710/313

(57) ABSTRACT

A first circuit and a second circuit perform communication using a first end point. The second circuit and an external device perform communication using a second end point. Upon receiving receive data from the external device with communication using the second end point, the second circuit gives first information indicating the second end point to the receive data. The second circuit sends the receive data given the first information to the first circuit with communication using the first end point. The first circuit interprets the second end point based on the first information given to the received receive data.

### CROSS-REFERENCE TO RELATED APPLICATIONS

This application claims priority to Japanese Patent Application No. 2013-196657 filed on Sep. 24, 2013. The entire disclosure of Japanese Patent Application No. 2013-196657 is hereby incorporated herein by reference.

### BACKGROUND

1. Technical Field

The present invention relates to a communication device for performing data communication with an external device.

2. Related Art

In the past, known are communication devices that perform communication using a communication path compatible with the USB (Universal Serial Bus) standard or the like. Also, with the USB standard, it is possible to set a plurality of end point configurations in relation to one physical communication path. Specifically, even when between devices are connected using a physical communication path such as a wire or the like, by setting end point configurations that differentiate this communication path into a plurality, it is possible to perform parallel communication using one communication path (see JP-A-2008-46858 (Patent Document 1), for example).

### SUMMARY

The pass-through method is known as a communication method compliant with the USB standard. With this pass-through method, first, a relay circuit is interposed between the sending side circuit and the receiving side circuit (or device), and the circuits are serially connected using a USB method communication path. Also, the relay circuit sends send data to the receiving side circuit without performing any kind of processing on the send data that is input through the communication path from the sending side circuit.

With performing this kind of pass-through method as a prerequisite, it is necessary that the end point configuration between the sending side circuit and the relay circuit and the end point configuration between the relay circuit and the receiving side circuit match. Here, matching means that all the end point configuration types match. Specifically, when the end point configuration is defined in advance between the sending side circuit and the relay circuit, only a receiving side circuit with the same end point configuration could be used for applying the pass-through method.

An advantage of the present invention is to widen the selection of receiving side circuits or devices when performing pass-through method communication.

To resolve the problems noted above, an aspect of the present invention is equipped with a first circuit, and a second circuit. The first circuit and the second circuit are configured to perform a first communication using end points including a first end point. The second circuit and an external device are configured to perform a second communication using end points including a second end point. Upon receiving receive data from the external device with communication using the second end point, the second circuit is further configured to give first information indicating the second end point to the receive data. The second circuit is further configured to send the receive data given the first information to the first circuit with communication using the first end point. The first circuit is further configured to interpret the second end point for the receive data based on the first information given to the received receive data. Also, another aspect of this is a communication device that can be connected with an external device via a communication path, having a first circuit, and a second circuit connected with the first circuit using a first interface, and connected with the external device using a second interface, wherein when receive data is received from the external device, the second circuit sets first information indicating a second end point for the second interface in the receive data, and sends the receive data for which the first information was set to the first circuit from the first interface with a first end point that differs from the second end point, and the first circuit has a data interpretation unit that interprets the second end point for the receive data based on the first information given to the received receive data.

With the invention configured as noted above, even when the first end point between the first circuit and the second circuit differs from the second end point between the second circuit and the external device, the receive data can be interpreted appropriately based on the first information.

Also, with one aspect of the present invention, the first circuit is further configured to give second information indicating an end point used with the first communication to send data. The first circuit is further configured to send the send data given the second information to the second circuit. The second circuit is further configured to send the send data to the external device with communication using an end point indicated by the second information given to the received send data.

With the invention configured as noted above, even when the first end point between the first circuit and the second circuit differs from the second end point between the second circuit and the external device, it is possible to send the send data appropriately based on the second information.

Because of that, the end point between the first circuit and the second circuit does not have to be matched with the end point between the second circuit and the external device. As a result, it is possible to widen the range of combinations of the first circuit, the second circuit, and the external device.

Also, with one aspect of the present invention, the second circuit is equipped with a recording unit that is configured to record usage state of a plurality of end points for the first communication or interface, and a selection unit that is configured to select an end point that is not being used as the first end point among the end points recorded in the recording unit.

With the invention configured as noted above, it is possible to apply the present invention even when dynamically changing the end points between the first circuit and the second circuit.

Also, with one aspect of the present invention, the first circuit includes a data interpretation unit having a driver for controlling driving of the external device.

With the invention configured as noted above, it is possible to mount the driver for controlling the driving of the external device inside the first circuit, making it possible to increase the flexibility of the design in terms of circuit arrangement.

Also, with one aspect of the present invention, the second circuit is further configured to perform communication with the external device to determine the second end point before receiving the receive data from the external device.

With the invention configured as noted above, it is possible to more flexibly determine the end point defined between the second circuit and the external device.

Also, with one aspect of the present invention, the second circuit is further configured to set third information indicating sending object of the receive data in the receive data upon receiving the receive data from the external device.

With the invention configured as noted above, even in a case when the second circuit receives receive data of a different send object, it is possible differentiate between receive data.

Also, with one aspect of the present invention, the configuration can also be such that the first circuit is equipped with a network communication unit that is configured to perform communication with an external device through a network, and the first circuit is further configured to send data fetched through the network from the external device to the second circuit using the first communication or interface.

With the invention configured as noted above, by equipping the first circuit with a function of providing data fetched through the network to the second circuit, it is possible to limit the function of the second circuit to an item compliant with the USB standard.

It is also possible to have a configuration such that the first communication and the second communication are connected with communication based on the same communication standard (e.g. USB standard).

### BRIEF DESCRIPTION OF THE DRAWINGS

Referring now to the attached drawings which form a part of this original disclosure;

FIG. 1 is a perspective view for describing a communication system 100;

FIG. 2 is a block schematic diagram for describing the configuration of a printer 1;

FIG. 3 is a block schematic diagram for describing the configuration of an authentication device 5;

FIG. 4 is a drawing showing the end point configuration set with an internal communication path 30 and an external communication path 2;

FIG. 5 is a drawing for describing send data 300 sent through each end point;

FIG. 6 is a timing chart for describing communication performed between the printer 1 and the authentication device 5;

FIG. 7 is a flow chart for describing a header providing process performed by a second circuit 20;

FIG. 8 is a flow chart for describing the issuing process executed at step SA1; and

FIG. 9 is a timing charge for describing the bus operation performed between a first circuit 10 and the second circuit 20.

### DETAILED DESCRIPTION OF EMBODIMENTS

Following, we will describe embodiments of the present invention according to the following sequence.

### 1. First Embodiment

1.1. Communication Device Configuration:

1.2. Pass-through:

1.3. Bus Operation:

### 2. Second Embodiment

### 3. Other Embodiments:

### 1. First Embodiment

### 1.1. Communication Device Configuration

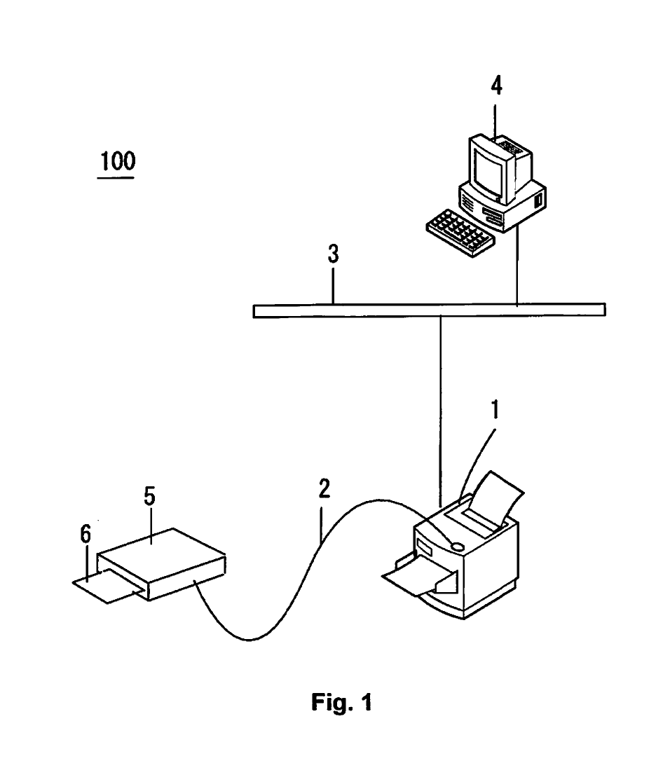

FIG. 1 is a perspective view for describing a communication system 100.

The communication system 100 is equipped with a printer 1, an authentication device 5, and a PC 4. With this embodiment, the communication device is realized using the printer 1. The printer 1 is connected with the authentication device 5 through an external communication path 2 compatible with the USB standard. The printer 1 is also connected with the PC 4 through a network 3. The communication path 2 and the network 3 are general terms that include both wired and wireless.

With the communication system 100, the printing process using the printer 1 is enabled by the user inserting an authentication card 6 in the authentication device 5. Also, by the user operating the PC 4, it is possible to download the image data recorded in the PC 4 through the network 3 and to have it printed by the printer 1.

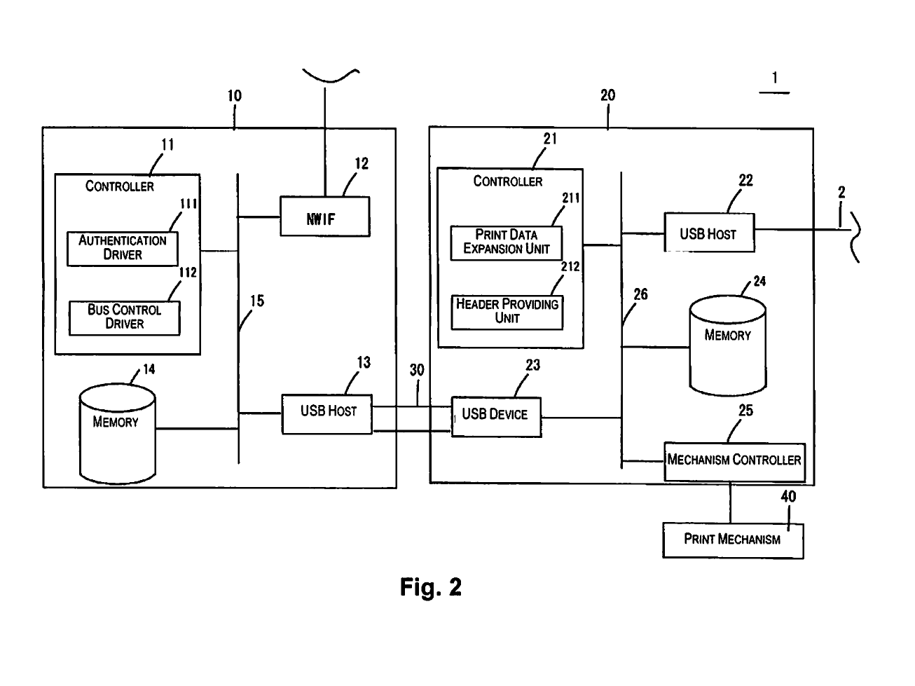

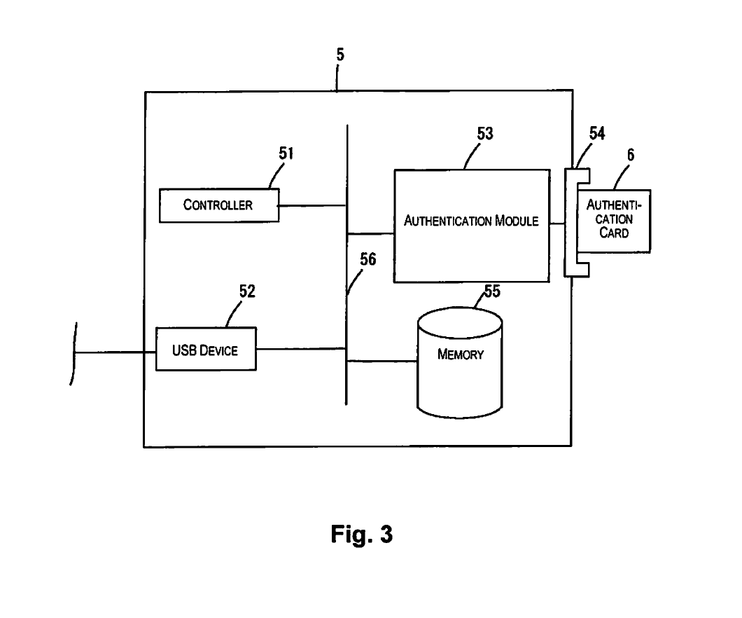

FIG. 2 is a block schematic diagram for describing the configuration of the printer 1. Also, FIG. 3 is a block schematic diagram for describing the configuration of the authentication device 5.

The printer 1 has a first circuit 10, a second circuit 20, an internal communication path 30, and a printing mechanism 40. Also, the first circuit 10 and the second circuit 20 are connected to be able to communicate through the internal communication path 30. Also, the second circuit 20 is connected to be able to communicate with the authentication device 5 through the detachably connected external communication path 2.

The first circuit 10 is equipped with a controller 11, an NWIF 12, a USB host 13, and a memory 14. The controller 11 is equipped with a CPU (Central Processing Unit), a ROM (Read Only Memory), a RAM (Random Access Memory) or the like, for example. Also, the controller 11 is electrically connected respectively to the NWIF 12, the USB host 13, and the memory 14 through a bus 15.

Also, the controller 11 is functionally equipped with an authentication driver 111 and a bus control driver 112 by executing a program recorded in the ROM.

The NWIF (Network Interface) 12 is configured by a well-known LAN board or a LAN card, for example. The NWIF 12 functions as an interface according to the TCP/IP protocol that connects the first circuit 10 to the network 3. The NWIF 12 performs data and command communication with the PC 4 under the control of the controller 11.

It is also possible to realize the NWIF 12 as a LAN chip mounted on the interior of the controller 11.

Because of that, the network communication unit of the present invention is realized by the NWIF 12.

The USB host 13 performs communication with a USB device 23 of the second circuit 20 in compliance with the USB (Universal Serial Bus) standard. The USB host 13 sets an end point configuration which is a logical communication path with the USB device 23 mounted in the second circuit 20.

The end point configuration logically divides the physical internal communication path 30 into a plurality of communication paths. The USB method that the USB host 13 is compatible with is USB 2.0 or USB 3.0. The USB host 13 can also be an item realized as a USB chip mounted on the interior of the controller 11.

Buffer areas are dynamically allocated in the memory 14 according to each end point configuration set between the USB host 13 and the USB device 23. Specifically, the data sent from the USB device 23 to the USB host 13 is recorded in a specified buffer area of the memory 14 according to the corresponding end point configuration.

The authentication driver 111 functions as a driver for controlling the driving of the authentication device 5. The authentication driver 111 performs authentication processing to permit use of the printer 1 while performing data communication with the authentication device 5. With this embodiment, the data interpretation unit is realized using the authentication driver 111.

The bus control driver 112 functions as the driver that controls bus on, off, shutdown and the like of the external communication path 2 connected to the second circuit 20.

The second circuit 20 is equipped with a controller 21, a USB host 22, a USB device 23, a memory 24, and a mechanism controller 25. The controller 21 is equipped with a CPU, ROM, and RAM, for example. The controller 21 is connected respectively to the USB host 22, the USB device 23, the memory 24, and the mechanism controller 25 through a bus 26. Because of that, the controller 21 is electrically interposed between the USB device 23 and the USB host 22.

Also, the controller 21 is functionally equipped with a print data expansion unit 211 and a header providing unit 212 by executing programs recorded in the ROM.

The USB device 23 performs communication with the USB host 13 of the first circuit 10 according to the USB standard. Also, an end point configuration which is a logical communication path is set between the USB device 23 and the USB host 13. With this embodiment, the USB device 23 functions as a first interface.

The USB host 22 performs communication in compliance with the USB standard with a USB device 52 of the authentication device 5. Specifically, an end point configuration which is a logical communication path is set between the USB host 22 and the USB device 52 of the authentication device 5. With this embodiment, the USB host 22 functions as a second interface.

Dynamically allocated in the memory 24 are buffer areas according to the end point configuration set between the USB host 13 and the USB device 23 and also according to the end point configuration set between the USB host 22 and the USB device 52. Specifically, the data sent from the USB host 13 to the USB device 23, or the data sent from the USB device 52 to the USB host 22 is recorded in a specified buffer area of the memory 24 according to the corresponding end point configuration.

The mechanism controller 25 drives the printing mechanism 40 based on printing data decoded by the print data expansion unit 211. This print data is fetched from the PC 4 through the NWIF 12 of the first circuit 10, for example.

The printing mechanism 40 is electrically connected to the mechanism controller 25. The printing mechanism 40 has a conveyance mechanism (not illustrated) and a print head (not illustrated). The print head is connected to cartridges corresponding to various liquids including cyan, magenta, yellow, black, light cyan, light magenta, and gray, for example, and discharges ink supplied from each cartridge.

The conveyance mechanism is equipped with a paper feed motor or a paper feed roller, and by having drive controlled by the mechanism controller 25, material to be printed is conveyed along the feed direction which is the direction in which paper is conveyed.

Also, as shown in FIG. 3, the authentication device 5 is equipped with a controller 51, a USB device 52, an authentication module 53, and a memory 55. The authentication device 5 has its drive controlled by the authentication driver 111 that the first circuit 10 is equipped with. Because of that, communication between the authentication device 5 and the authentication driver 111 is performed using “pass-through” for which the second circuit 20 is interposed.

The controller 51 is electrically connected through a bus 56 to the USB device 52, the authentication module 53, and the memory 55. Also, the controller 51 controls the driving of the USB device 52 and the authentication module 53.

The USB device 52 performs wireless communication with the USB host 22 of the second circuit 20 in compliance with the USB standard. Specifically, an end point configuration which is a logical communication path is set between the USB device 52 of the authentication device 5 and the USB host 22 of the second circuit 20.

The memory 55 has buffer areas dynamically allocated according to the end point configurations set between the USB host 22 and the USB device 23. Specifically, the data sent from the USB host 22 to the USB device 52 is recorded in a specific buffer area of the memory 55 according to the corresponding end point configuration.

The authentication module 53 is configured by a reading device such as a card reader or the like, for example. Also, when the authentication card 6 is inserted in a card slot 54, the authentication module 53 reads the authentication information recorded in this authentication card 6, and outputs this authentication information to the controller 51. When the controller 51 receives sending of a command indicating reading (read command) of this authentication information from the printer 1, the read authentication information (read data) is output to the USB device 52. The USB device 52 sends the authentication information to the printer 1 through a specified end point configuration set with the USB host 22 of the second circuit 20.

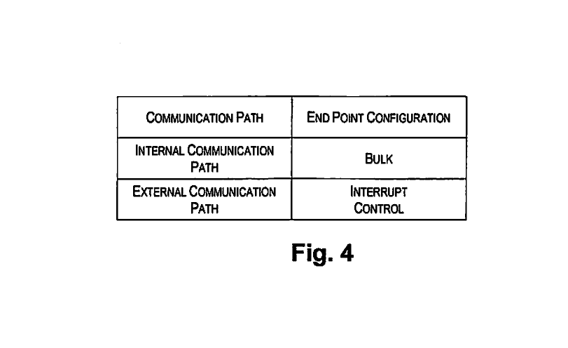

FIG. 4 is a drawing showing the end point configuration set with the internal communication path 30 and the external communication path 2. With this embodiment, “Bulk” is used for the end point configuration with the internal communication path 30 that connects the first circuit 10 and the second circuit 20. Because of that, “Bulk-OUT” is used for sending of send data from the USB host 13 of the first circuit 10 to the USB device 23 of the second circuit 20. Also, “Bulk-IN” is used for sending of send data from the USB device 23 of the second circuit 20 to the USB host 13 of the first circuit 10.

Also, “Interrupt” or “Control” is used for the end point configuration with the external communication path 2 that connects the second circuit 20 and the authentication device 5. Because of that, “Interrupt-OUT” or “Control-OUT” is used for sending of send data from the USB host 22 of the second circuit 20 to the USB device 52 of the authentication device 5. Also, “Interrupt-IN” or “Control-IN” is used for sending of the send data from the USB device 52 of the authentication device 5 to the USB host of the second circuit 20.

Of course, the number of and configuration of the end points described here are merely examples. There can be one, or two or more end points for the internal communication path 30 and the external communication path 2.

Before receiving data from the authentication device 5, the second circuit 20 performs communication with the authentication device 5, and determines the end point configuration (second end point configuration). Because of that, it is possible to more flexibly determine the end point configuration defined between the second circuit 20 and the authentication device 5.

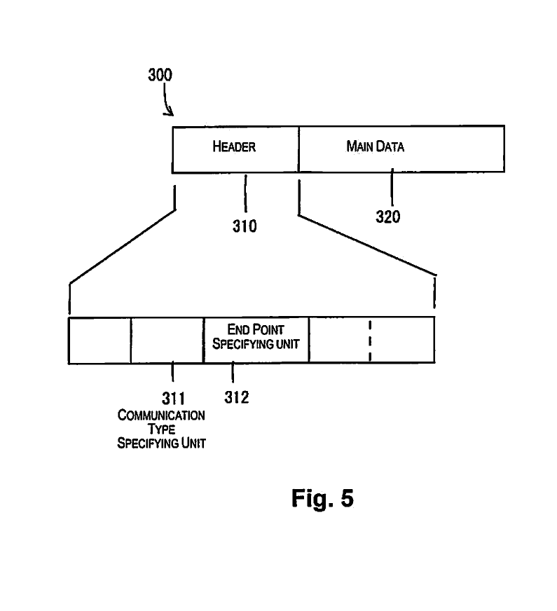

FIG. 5 is a drawing for describing the send data 300 sent through each end point. The send data 300 is equipped with a header 310 and main data 320. The header is given at the time of communication between the first circuit 10 and the second circuit 20. Also, various types of information for identifying the contents of the main data 320 is stored in the header 310. With this embodiment, the header 310 is equipped with a communication type specifying unit 311 and an end point specifying unit 312.

The communication type specifying unit (second information) 311 shows the communication type that communicates the send data. With this embodiment, the communication type specifying unit 311 at least identifies one of the communication types “pass-through” or “bus operation.” “Pass-through” is a communication method by which the second circuit 20 performs data relay. Specifically, with this “pass-through,” the send data 300 sent from the authentication device 5 is sent to the first circuit 10 via the USB host 22 and the USB device 23 of the second circuit 20. Also, with “pass-through,” the send data 300 sent from the first circuit 10 is sent to the authentication device 5 via the USB device 23 and the USB host 22 of the second circuit 20.

“Bus operation” is a process performed by the bus control driver 112 of the first circuit 10 on the USB host 22 of the second circuit 20.

The end point specifying unit 312 shows the end point configuration when the send data 300 is sent. For example, when sending of the send data 300 is performed by “Interrupt-IN” as the end point configuration from the authentication device 5, “Interrupt-IN” is shown in the end point specifying unit 312.

The main data 320 is data subject to processing with the first circuit 10, the second circuit 20, and the authentication device 5. For example, this includes control commands, authentication data or the like.

When the communication method is “pass-through,” communication between the authentication device 5 and the authentication driver 111 is performed via the second circuit 20. Here, the authentication driver 111 interprets the send data 300 sent from the authentication device 5 according to the end point configuration. For example, the “detection signal” sent from the authentication device 5 can be interpreted when sent with “Interrupt-IN,” but cannot be interpreted with other end point configurations including “Control.” However, because the second circuit 20 is interposed between the first circuit 10 and the authentication device 5, when the end point configuration with the first circuit 10 differs from that of the second circuit 20, it becomes impossible for the authentication driver 111 to suitably interpret the send data 300. Because of that, with the conventional “pass-through,” it was necessary to match the end point configuration set between the authentication device 5 and the second circuit 20, and the end point configuration set between the second circuit 20 and the first circuit 10.

In light of that, with the present invention, when giving the end point specifying unit 312 to specify the end point configuration to the header 310 of the send data 300, and the second circuit 20 relays the send data 300, even when the end point configuration changes, it is possible to be able to determine the original end point configuration.

### 1.2. Pass-Through

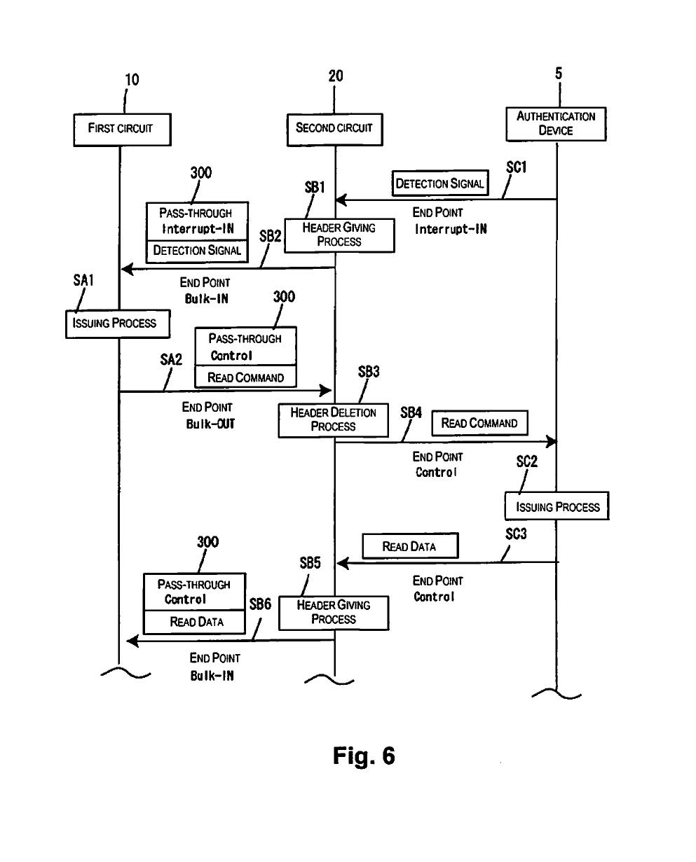

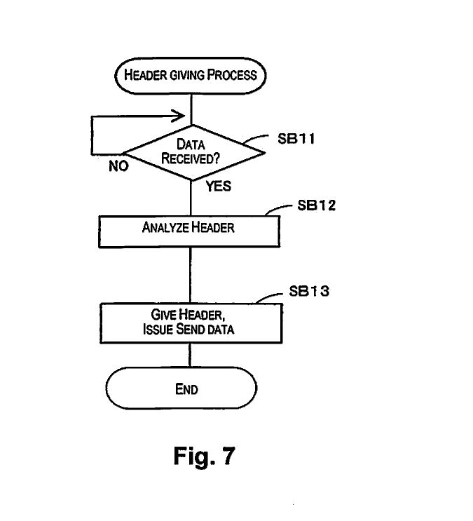

FIG. 6 is a timing chart for describing the communication performed between the printer 1 and the authentication device 5. Also, FIG. 7 is a flow chart for describing the head giving process performed by the second circuit 20. With the process shown in FIG. 6, setting of the end point configuration performed between the first circuit 10 and the second circuit 20 and setting of the end point configuration performed between the second circuit 20 and the authentication device 5 are performed ahead of time.

When the controller 51 of the authentication device 5 detects that the authentication card 6 has been inserted into the card slot 54, the controller 51 sends the detection signal using the USB device 52 at step SC 1. At this time, the detection signal is sent from the USB device 52 of the authentication device 5 to the USB host 22 of the second circuit 20 using end point configuration “Interrupt-IN.” This end point configuration is arranged in advance with the authentication driver 111.

When the USB host 22 of the second circuit 20 receives the detection signal, it performs the header giving process at step SB1. FIG. 7 is a flow chart showing the details of the header giving process executed at step SB1.

First, at step SB11 of FIG. 7, when data is received by the second circuit 20 through the USB host 22 (step SB11: Yes), at step SB12, the header providing unit 212 analyzes the data. With this embodiment, the data includes the “detection signal” that detects that the authentication card 6 was inserted by the controller 51 of the authentication device 5.

As an example, the header providing unit 212 references a table (not illustrated) recorded in the memory 24, and judges that the detection signal corresponds to the “pass-through” communication method.

Then, at step SB13, the header providing unit 212 gives data (detection signal) to the header 310, and generates send data 300. With this embodiment, the header providing unit 212 sets “pass-through” for the communication type specifying unit 311 included in the header 310. Similarly, the header providing unit 212 sets “Interrupt-IN” for the end point specifying unit 312 included in the header 310.

Then, returning to FIG. 6, at step SB2, the controller 21 sends the send data 300 to the first circuit 10 using the USB device 23. At this time, the send data 300 is sent using the end point configuration (Bulk-1N) set between the first circuit 10 and the second circuit 20.

With the first circuit 10, when the send data 300 is received using the end point configuration (Bulk-IN), the authentication driver 111 analyzes the send data 300 and issues new send data (SA 1). With this embodiment, when the authentication driver 111 receives the detection signal, it issues a read command to read the authentication data recorded on the authentication card 6.

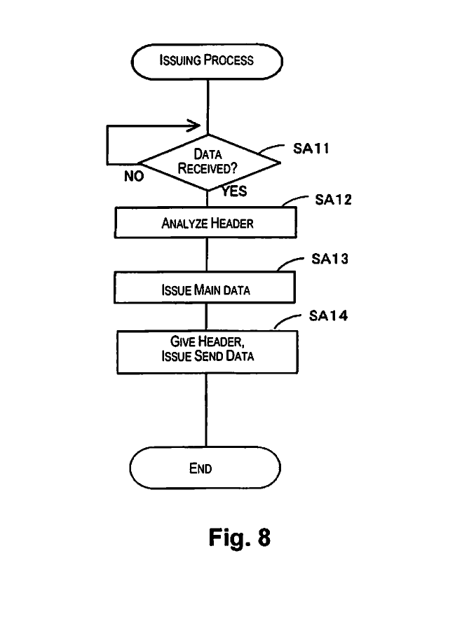

FIG. 8 is a flow chart for describing the issuing process executed at step SA1. When the authentication driver 111 of the first circuit 10 receives the send data 300 from the second circuit 20 (step SA11: Yes), at step SA12, it analyzes the header 310 of the send data 300. With this embodiment, the header 310 of the send data 300 sent from the second circuit 20 has “Interrupt-IN” for the end point specifying unit 312. Because of that, the authentication driver 111 interprets the main data 320 to be a “detection signal” based on the header 310. Of course, the authentication driver 111 can also be an item which adds the communication type specifying unit 311 being “pass-through” as a judgment element.

At step SA13, the authentication driver 111 issues new main data 320 according to the received send data 300. In specific terms, the authentication driver 111 issues a command (read command) according to the reply signal and uses that as the main data 320.

At step SA14, the authentication driver 111 gives the header 310 to the issued main data 320, and issues the send data 300. With this embodiment, for the authentication driver 111 to send the “read command” to the authentication device 5, the header 310 of the send data 300 has the communication type set as “pass-through” and the end point configuration set as “Control.” At step SA14, the set communication type and end point are pre-arranged settings between the authentication driver 111 and the authentication device 5.

Then, returning to FIG. 6, at step SA2, the USB host 13 of the first circuit 10 sends the newly issued send data 300 with the end point configuration “Bulk-OUT” set with the USB device 23 of the second circuit 20.

With the second circuit 20, when the header providing unit 212 receives the send data 300 sent from the first circuit 10, at step SB3, a header deletion process that deletes the header 310 of the send data 300 is performed. Then, at step SB4, the USB host 22 of the second circuit 20 sends data (read command) to the USB device 52 of the authentication device 5 using the end point (Control).

With the authentication device 5, when data sent from the second circuit 20 is received, since the end point configuration is “Control,” it is judged that the data is a “read command.” Then, at step SC2, an issuing process of issuing data corresponding to the read command (read data) is issued. Then, at step SC3, the read data read from the authentication card 6 is sent from the end point configuration (Control).

At step SB5, the second circuit 20 performs the header giving process on the data sent from the authentication device 5 (read data). This header giving process is the same as the process at step SB1. Then, at step SB6, the second circuit 20 sends the newly issued send data 300 to the first circuit 10 with the end point configuration (Bulk-IN).

With this embodiment as described above, even in a case when the end point configuration between the first circuit 10 and the second circuit 20 differs from the end point configuration between the second circuit 20 and the authentication device 5, it is possible for the authentication driver 111 to interpret the end point configuration for the send data 300 based on the information given to the header 310.

Because of that, it is not necessary to match the end point configuration between the first circuit 10 and the second circuit 20, and the end point configuration between the second circuit 20 and the authentication device 5. As a result, it is possible to widen the selection of combinations of the first circuit, the second circuit, and the authentication device (external device) 5.

It is also possible to mount the driver for controlling the driving of the external device inside the first circuit, so it is possible to increase the flexibility of design relating to circuit arrangement.

### 1.3. Bus Operation

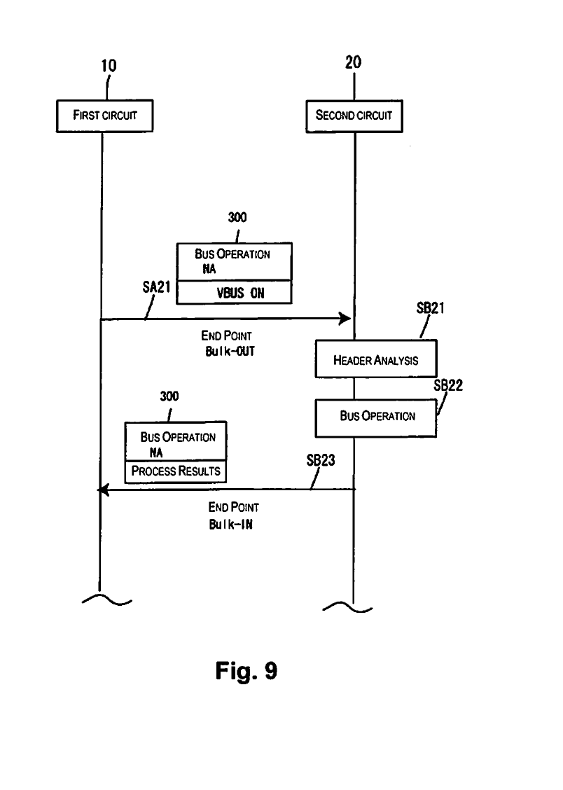

FIG. 9 is a timing flow chart for describing the bus operation performed between the first circuit 10 and the second circuit 20. With this bus operation, a command “VBUS ON Operation” to turn on the bus of the communication path 30 is sent to the second circuit 20 from the bus control driver 112 of the first circuit 10.

First, at step SA21, the “VBUS ON Operation” that turns on the bus of the communication path 30 is sent using end point (Bulk-OUT) to the second circuit 20 from the bus control driver 112 of the first circuit 10. In specific terms, the bus control driver 112 sets the communication type specifying unit 311 constituting the header 310 of the send data 300 to “bus operation.”

Also, the bus control driver 112 sets the end point specifying unit 312 constituting the header 310 to “NA.” Specifically, with “bus operation,” the end point specifying unit 312 is not specified. Furthermore, the bus control driver 112 has the main data 320 as “VBUS ON Operation.”

When the second circuit 20 receives the send data 300, at step SB21, the controller 21 analyzes the header 310 of the send data 300, and judges that the send data 300 is “bus operation.” Because of that, at step SB22, the controller 21 turns on the bus of the communication path 30 in relation to the USB host 22. Then, at step SB23, the controller 21 replies to the first circuit 10 using the end point (Bulk-IN) with “processing results” showing that the processing has finished. At this time, as the header 310 given to the “processing results” which are the main data, the controller 21 sets the communication type specifying unit 311 to “bus operation,” and sets the end point specifying unit 312 to “NA.”

As described above, the communication type specifying unit 311 (second information) showing the sending object of the send data 300 is given to the header 310, so using the first circuit 10 or the second circuit 20, it is possible to differentiate when the send data 300 is “pass-through” from a case when it is “bus operation.”

### 2. Second Embodiment

It is also possible to use the following kind of configuration for the end point configuration set between the first circuit 10 and the second circuit 20. Specifically, the controller 21 of the second circuit 20 records the usage state of the plurality of end point configurations in the memory (recording unit) 24. Also, the controller 21 selects as the end point configuration set between the first circuit 10 and the second circuit 20 (first end point configuration) the end point configuration that is not yet used among the end point configurations recorded in the memory 24. For example, when “Bulk” and “Control” are recorded in the memory 24, we'll assume a case when with the second circuit 20, “Bulk” is used as the end point configuration for the send data sent to the mechanism controller 25. In such a case, the controller 21 uses “Control” as the end point configuration used with “pass-through” between the first circuit 10 and the second circuit 20.

Because of that, the controller 21 functions as the selection unit of the present invention.

By configuring as noted above, even when the end point configuration between the first circuit 10 and the second circuit 20 is dynamically changed, it is possible to use “pass-through” without changing the end point configuration between the second circuit 20 and the authentication device 5.

### 3. Other Embodiments

The controller 11 of the first circuit 10 can also be functionally equipped with the print data expansion unit 211. In this case, first, the controller 11 fetches print data from the PC 4 through the NWIF 12. Next, the print data expansion unit 211 of the controller 11 decodes the fetched print data, and outputs it to the mechanism controller 25 through the internal communication path 30. The mechanism controller 25 drives the printing mechanism 40 based on the decoded print data.

Also, the controller 11 of the first circuit 10 can also be an item having a function as a printer driver for changing the image data supplied from the PC 4 to print data that can be processed by the printer 1.

By integrating the functions of performing communication with the PC 4 on the first circuit 10, it is possible to limit the function of the second circuit 20 to only USB communication. As a result, it is possible make the circuit configuration of the second circuit 20 simpler.

Also, when the external device connected with the second circuit 20 is selected from a plurality, it is also possible to have a case when depending on the connected external device, all the end points of the internal communication path 30 and the external communication path 2 match. In this case, it is acceptable to communicate with the pass-through method as with the prior art, and when at least one part of the end points of the internal communication path 30 and the external communication path 2 differs, the operation can be done as described above.

It goes without saying that the present invention is not limited to the embodiments noted above.

Specifically, it is also possible to suitably change the mutually interchangeable members, constitutions and the like and suitable combinations thereof disclosed in the embodiments noted above.

It is also possible to apply this to other communication standards for performing communication using end point such as with USB communication.

It is also possible to suitably replace members, constitutions or the like disclosed in the embodiments noted above with mutually interchangeable members, constitutions and the like that are known technology, and to change and apply combinations thereof.

It is also possible to suitably exchange members, constitutions and the like that can be assumed to be substitutes for the members, constitutions and the like disclosed in the embodiments noted above by a person skilled in the art based on known technology or the like, and also to change and apply combinations thereof.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A communication device comprising:
a first circuit; and
a second circuit,
the first circuit and the second circuit being configured to perform a first communication using end points including a first end point,
the second circuit and an external device being configured to perform a second communication using end points including a second end point,
upon receiving receive data from the external device with communication using the second end point, the second circuit being further configured to give first information indicating the second end point to the receive data,
the second circuit being further configured to send the receive data given the first information to the first circuit with communication using the first end point, and
the first circuit being further configured to interpret the second end point for the receive data based on the first information given to the received receive data.

2. The communication device according to claim 1, wherein
the first circuit is further configured to give second information indicating an end point used with the first communication to send data,
the first circuit is further configured to send the send data given the second information to the second circuit, and
the second circuit is further configured to send the send data to the external device with communication using an end point indicated by the second information given to the received send data.

3. The communication device according to claim 1, wherein
the second circuit further includes
a recording unit that is configured to record usage state of a plurality of end points for the first communication, and
a selection unit that is configured to select an end point that is not being used as the first end point among the end points recorded in the recording unit.

4. The communication device according to claim 1, wherein
the first circuit includes a data interpretation unit having a driver for controlling driving of the external device.

5. The communication device according to claim 1, wherein
the second circuit is further configured to perform communication with the external device to determine the second end point before receiving the receive data from the external device.

6. The communication device according to claim 1, wherein
the second circuit is further configured to set third information indicating sending object of the receive data in the receive data upon receiving the receive data from the external device.

7. The communication device according to claim 1, wherein
the first circuit further includes a network communication unit that is configured to perform communication with an external device through a network, and
the first circuit is further configured to send data fetched through the network from the external device to the second circuit using the first communication.

8. The communication device according to claim 1, wherein
the first communication and the second communication are communication based on a same communication standard.

9. The communication device according to claim 8, wherein
the first communication and the second communication are connected by communication based on a USB standard.

10. The communication device according to claim 7, wherein
the first circuit is further configured to process the receive data based on interpreted information on the second end point.
